(19) United States
(12) Patent Application Publication
(10) Pub. No.: US 2026/0126073 A1
(43) Pub. Date: May 7, 2026

(54) CLAW-TYPE RIVET-PULLING TOOL

(71) Applicant: KING POINT ENTERPRISE CO., LTD., Kaohsiung City (TW)

(72) Inventor: Wen-Pin HUANG, Kaohsiung City (TW)

(73) Assignee: KING POINT ENTERPRISE CO., LTD., Kaohsiung City (TW)

(21) Appl. No.: 18/937,785

(22) Filed: Nov. 5, 2024

(51) Int. Cl. F16B 19/10

(52) U.S. Cl. CPC F16B 19/1045

(57) ABSTRACT

A claw-type rivet-pulling tool comprises a tool base, a claw portion disposed at an end of the tool base, and a middle hole extending from the claw portion into the tool base. The claw portion comprises multiple clamping pieces, being expanded or contracted when operated. Each of the multiple clamping pieces has a backwardly-pulling clamping portion disposed at a tail end of said clamping piece and facing the middle hole. The claw-type rivet-pulling tool clamps a mandrel of a rivet assembly through the backwardly-pulling clamping portion of each of the multiple clamping pieces to pull it. The backwardly-pulling clamping portion clamps a backwardly-inclined cone of the mandrel, thus having a larger gripping area. Therefore, the mandrel is more stably clamped, contributing to the claw-type rivet-pulling tool pulling the mandrel and a pulling sleeve applying force to a rivet head of a rivet body of the rivet assembly for deformation.

### BACKGROUND OF THE INVENTION

### 1. Field of the Invention

The present invention relates to a tool used to rivet components through a rivet assembly, especially to a claw-type rivet-pulling tool.

### 2. Description of Related Art

Nowadays, a rivet assembly used to rivet multiple components of a to-be-riveted object comprises a rigid mandrel and a rivet body, which is deformable under pressing. The rivet assembly is mounted through preformed holes on multiple aligned components. Then, a rivet-pulling tool clamps an end of the mandrel to apply a pulling force. At the same time, a pulling sleeve mounted around the rivet-pulling tool presses the rivet body, so the rivet body deforms under pressure to rivet the multiple aligned components to each other.

Although the conventional rivet-pulling tool can rivet multiple aligned components, a shape of the conventional rivet-pulling tool matches a shape of a connecting section, which is to be clamped, of the mandrel of the rivet assembly. The conventional rivet-pulling tool is an elongated tube having a uniform diameter, and the connecting section is an elongated rod also having a uniform diameter. The connecting section has multiple clamping teeth located at its periphery for the tool to clamp to pull. Because the clamping teeth have limited depths, the connecting section, being elongated in shape, with clamping teeth can only provide a smaller gripping area. Thus, when the rivet-pulling tool connects the connecting section and applies force, the tool and the connecting section of the mandrel are prone to slip and detach, therefore being inconvenient in operation and affecting a rivet process of the rivet assembly.

### SUMMARY OF THE INVENTION

The objective of the present invention is to provide a claw-type rivet-pulling tool to resolve the drawback that a conventional rivet-pulling tool is inconvenient in operating.

The claw-type rivet-pulling tool comprises a tool base, a claw portion and a middle hole. The claw portion is disposed at an end of the tool base and comprises multiple clamping pieces, which are flexible and are expanded or contracted when operated. The middle hole is elongated from a terminal end of the claw portion into the tool base. Each one of the multiple clamping pieces comprises a tail end and a backwardly-pulling clamping portion disposed at an inner wall of the tail end. The multiple clamping pieces collaboratively clamp a mandrel of a rivet assembly through the backwardly-pulling clamping portion to pull the mandrel.

The claw-type rivet-pulling tool is used in a riveting process to rivet multiple components. The claw portion of the claw-type rivet-pulling tool clamps a connecting section of the mandrel. An inner surface of the backwardly-pulling clamping portion of the claw portion clamps and connects a backwardly-inclined cone of the connecting section, thus having a larger gripping area. Therefore, the connecting section is more stably clamped to apply force, contributing to the claw-type rivet-pulling tool pulling the mandrel, and a pulling sleeve applying force to a rivet head of a rivet body of the rivet assembly for deformation.

Additionally, the multiple clamping pieces, arranged annularly, of the claw portion clamp multiple radius annular recesses on a periphery of the connecting section respectively through the multiple clamping teeth, which protrude radially. The connection between the multiple clamping teeth, having a radial difference formed between each two adjacent clamping teeth, and multiple radius annular recesses enlarges a gripping area between the claw portion and the connecting section. Therefore, when the claw-type rivet-pulling tool clamps the connecting section of the mandrel to proceed with a pulling step, a larger gripping force is generated between the claw-type rivet-pulling tool and the connecting section. Simultaneously, areas where the claw-type rivet-pulling tool generates the gripping force toward the connecting section of the mandrel are distributed as multiple concentric circles with different radiuses. The multiple clamping teeth of the claw portion of the claw-type rivet-pulling tool respectively reach into different radius annular recesses of the connecting section that have different radial depths. The outermost clamping tooth reaches into the deeper radius annular recess, while other clamping teeth reach into other radius annular recesses that have the depths decreasing from outside to inside sequentially. Therefore, the connecting section is more stably clamped to apply force, contributing to the claw-type rivet-pulling tool pulling the mandrel, and the pulling sleeve applying force to the rivet head of the rivet body to make the rivet head deform.

In addition, by utilizing the inner surface of the backwardly-pulling clamping portion of the claw portion cooperating with a blocking stepped surface formed at a lateral end of the backwardly-pulling clamping portion inside the claw portion, the claw-type rivet-pulling tool more stably clamps the connecting section of the mandrel to apply force, ensuring that the mandrel does not slip and detach while being pulled.

### BRIEF DESCRIPTION OF THE DRAWINGS

FIG. 1 is a perspective view of an embodiment of a claw-type rivet-pulling tool in accordance with the present invention;

FIG. 2 is another perspective view of the embodiment of the claw-type rivet-pulling tool shown in FIG. 1;

FIG. 3 is a side view of the embodiment of the claw-type rivet-pulling tool shown in FIGS. 1 and 2;

FIG. 4 is a front view of the embodiment of the claw-type rivet-pulling tool shown in FIGS. 1 and 2;

FIG. 5 is a sectional side view of the embodiment of the claw-type rivet-pulling tool shown in FIGS. 1 and 2;

FIG. 6 is an enlarged view of section A shown in FIG. 5;

FIG. 7A is the first operational view of the claw-type rivet-pulling tool, in use to rivet a to-be-riveted object through a dual-directional rivet assembly;

FIG. 7B is the second operational view of the claw-type rivet-pulling tool, in use to rivet the to-be-riveted object through the dual-directional rivet assembly;

FIG. 7C is the third operational view of the claw-type rivet-pulling tool, in use to rivet the to-be-riveted object through the dual-directional rivet assembly;

FIG. 8A is the first operational view of the claw-type rivet-pulling tool, in use to rivet the to-be-riveted object through a uni-directional rivet assembly;

FIG. 8B is the second operational view of the claw-type rivet-pulling tool, in use to rivet the to-be-riveted object through the uni-directional rivet assembly;

FIG. 8C is the third operational view of the claw-type rivet-pulling tool, in use to rivet the to-be-riveted object through the uni-directional rivet assembly; and

FIG. 8D is the fourth operational view of the claw-type rivet-pulling tool, in use to rivet the to-be-riveted object through the uni-directional rivet assembly.

### DETAILED DESCRIPTION OF THE PREFERRED EMBODIMENT

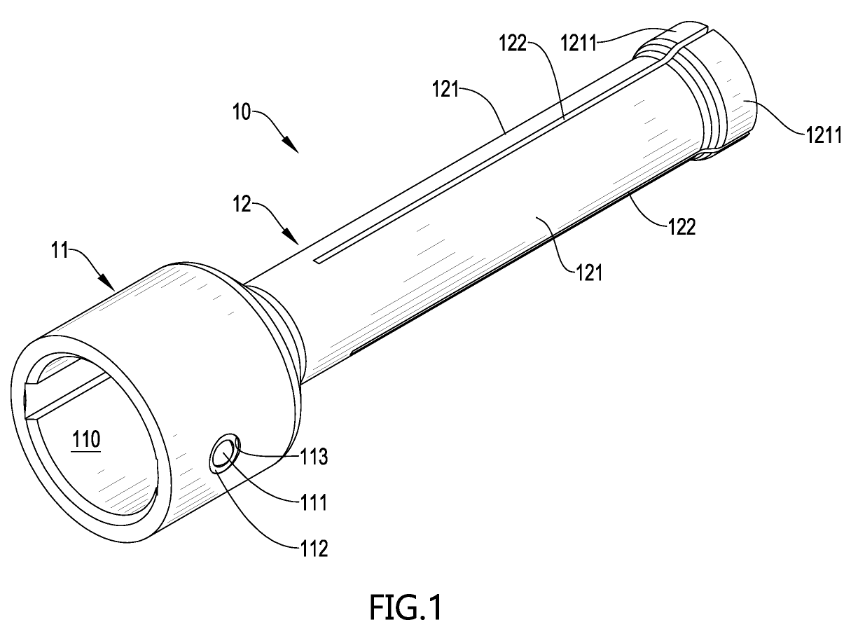

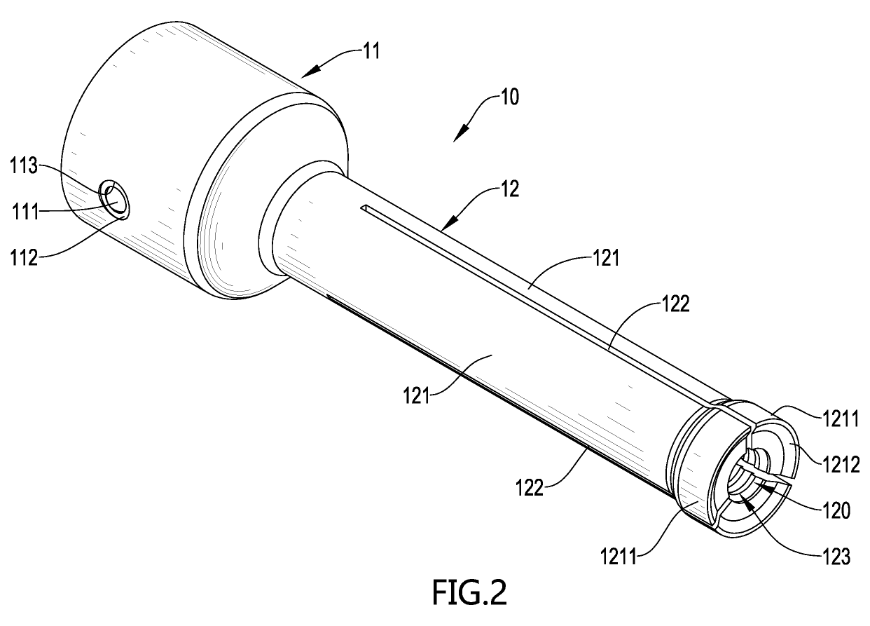

With reference to FIGS. 1 and 2, an embodiment of a claw-type rivet-pulling tool 10 comprises a tool base 11, a claw portion 12 and a middle hole 120. The claw portion 12 is disposed at an end of the tool base 11 and extends outwardly along an axis. The middle hole 120 is elongated inwardly along the axis from a terminal end of the claw portion 12 and is inside the claw portion 12.

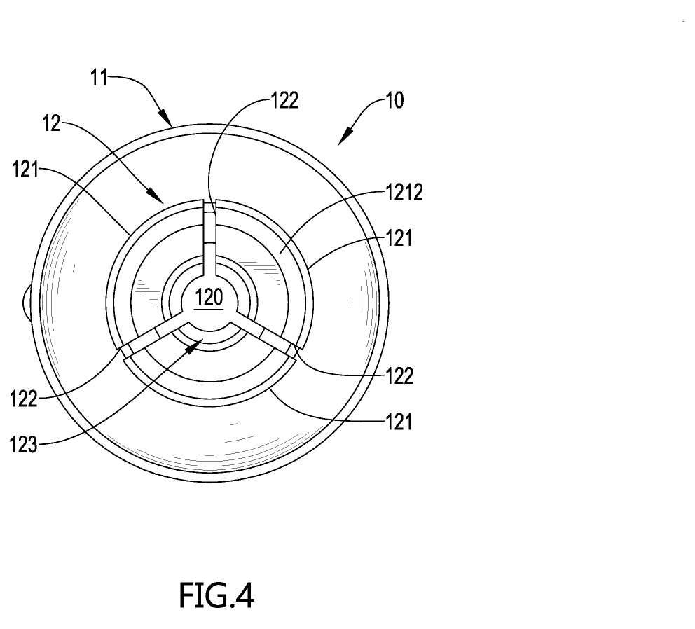

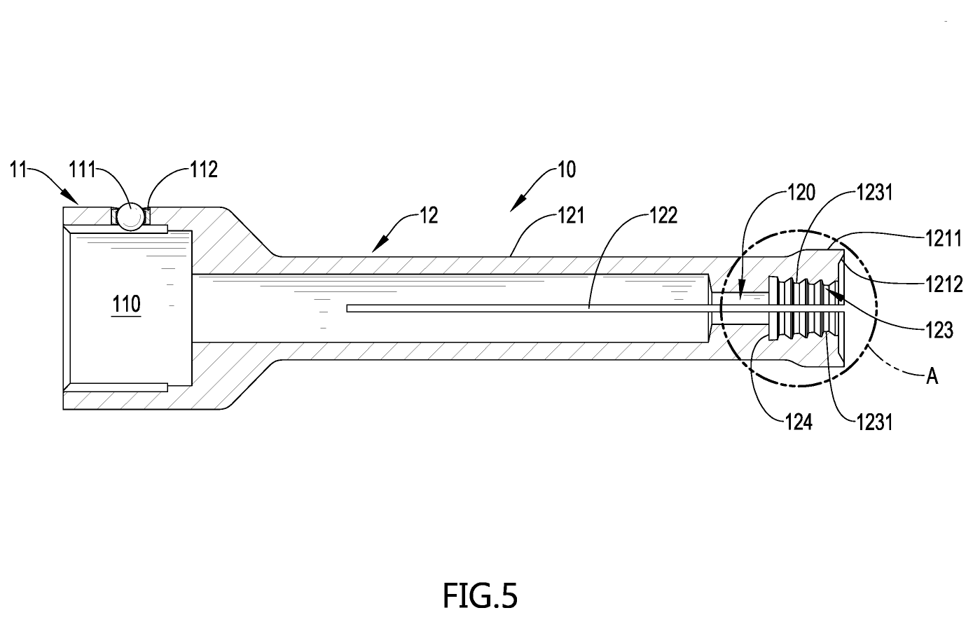

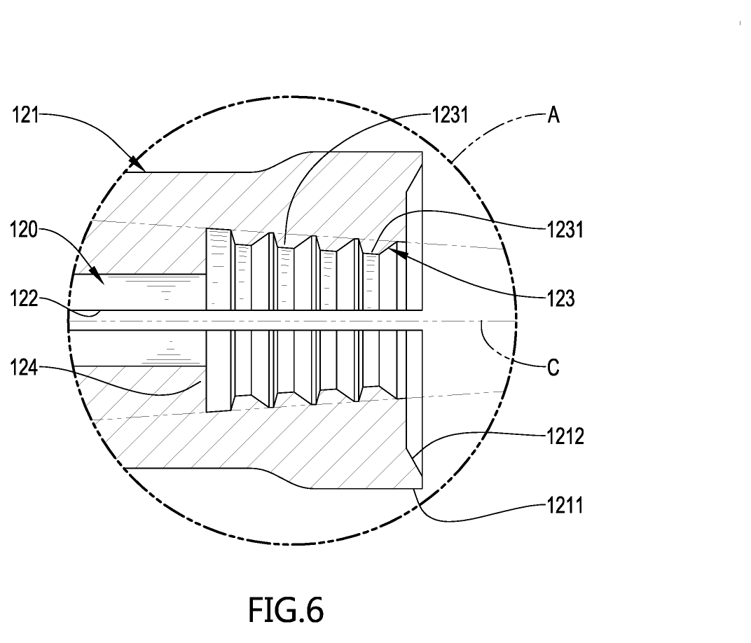

With reference to FIGS. 2 and 4 to 6, the claw portion 12 comprises multiple clamping pieces 121. In this embodiment, the claw portion 12 comprises multiple grooves 122 elongated from the terminal end of the claw portion 12 along the axis. One of the multiple clamping pieces 121 is formed between each two adjacent grooves 122. A tail end 1211 of each one of the multiple clamping pieces 121 is a free end, so each one of the multiple clamping pieces 121 is flexible and resilient. Therefore, the multiple clamping pieces 121 are capable of expanding or contracting when operated. Each one of the multiple clamping pieces 121 comprises a backwardly-pulling clamping portion 123 disposed at a lateral and inner wall, facing the middle hole 120, of said clamping piece 121. The backwardly-pulling clamping portion 123 extends inwardly from the tail end 1211 of said clamping piece 121 and inclines away from a central axis C of the claw portion 12. Which being said, a radial distance between an outer end of the backwardly-pulling clamping portion 123 and the central axis C is shorter than a radial distance between an inner end of the backwardly-pulling clamping portion 123 and the central axis C.

With reference to FIGS. 2, 5 and 6, in this embodiment, the backwardly-pulling clamping portion 123 of each one of the multiple clamping pieces 121 comprises multiple clamping teeth 1231. Each two adjacent clamping teeth 1231 have a radial difference formed therebetween. Each one of the multiple clamping pieces 121 further comprises a blocking stepped surface 124 formed in an inner wall of said clamping piece 121 and disposed between the multiple clamping teeth 1231 and the tool base 11 and at a lateral end of the backwardly-pulling clamping portion 123. Each one of the multiple clamping pieces 121 comprises a guiding inclined surface 1212 disposed at a terminal surface of the terminal end 1211 of said clamping piece 121.

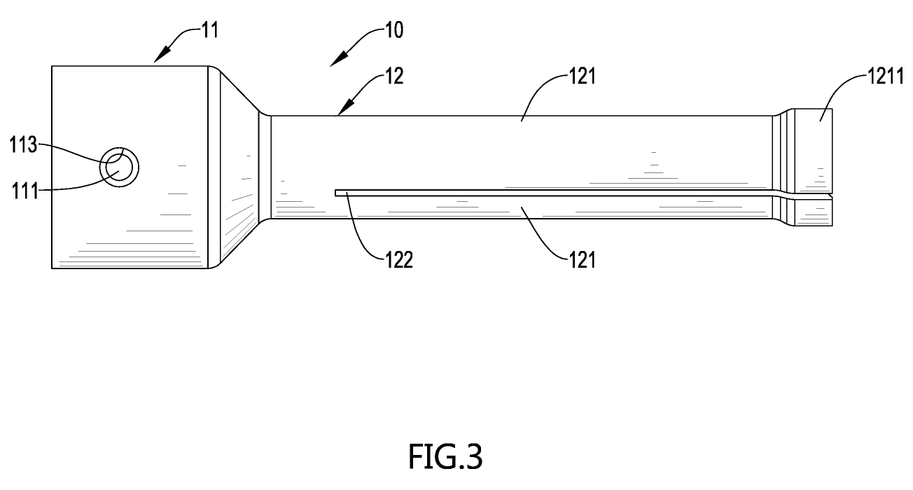

With reference to FIGS. 1 to 3 and 5, the tool base 11 comprises an assembling hole 110 communicating with the middle hole 120. An installing hole 113 is disposed at a peripheral wall of the tool base 11 and communicates with the assembling hole 110. The tool base 11 comprises a ball seat 112, which is mounted inside the installing hole 113, and a steel ball 111 mounted in the ball seat 112. When the claw-type rivet-pulling tool 10 is connected to an operating tool through the tool base 11, the steel ball 111 can be engaged with and connected to the operating tool.

The embodiment of the claw-type rivet-pulling tool 10 can be used to rivet a to-be-riveted object 40 with a rivet assembly 30. Assembling directions of the rivet assembly 30 can be altered according to how multiple components of the to-be-riveted object 40 will be connected. An operating process of riveting is altered depending on whether the chosen rivet assembly 30 is operated uni-directionally or dual-directionally. Basically, riveting comprises a drilling step, an assembling step, a clamping step and a pulling step, which are to be elaborated as follows.

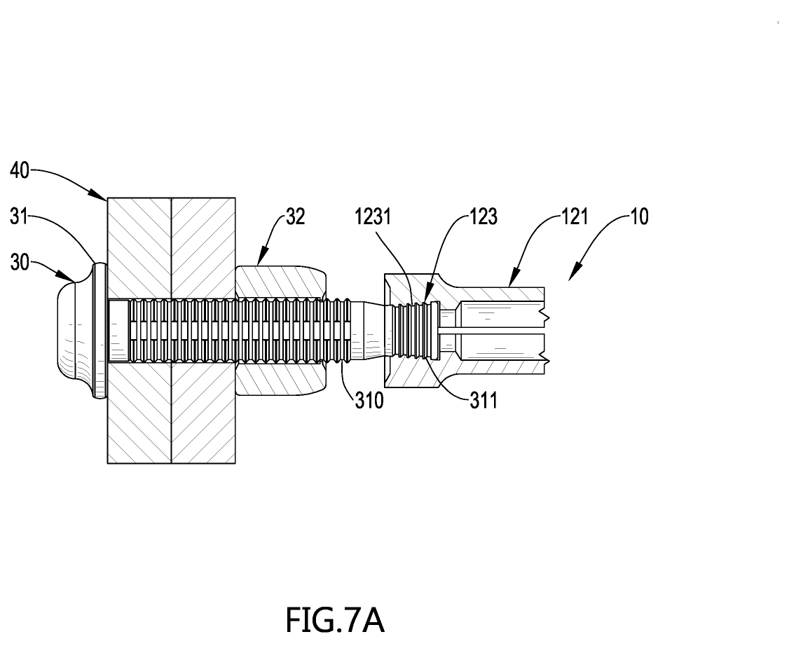

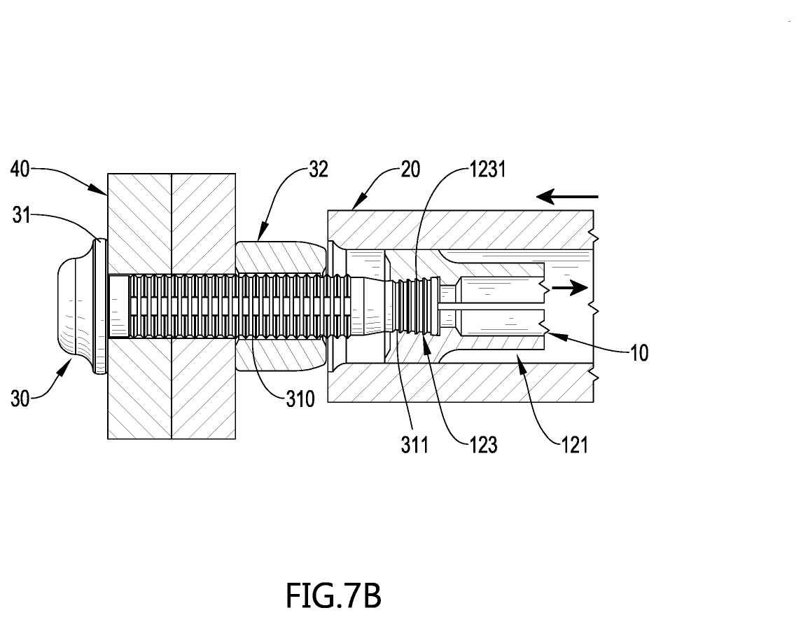

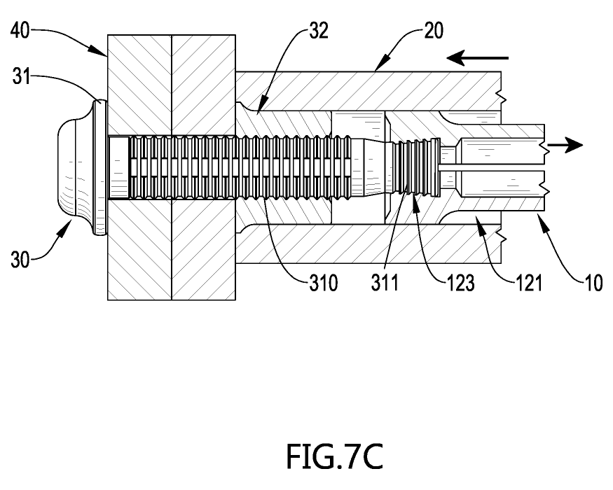

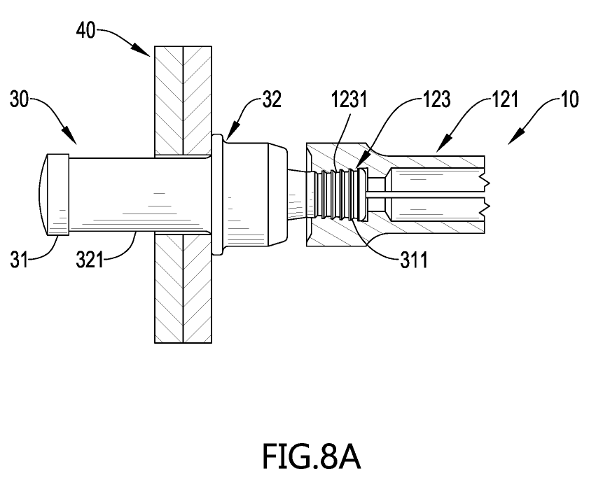

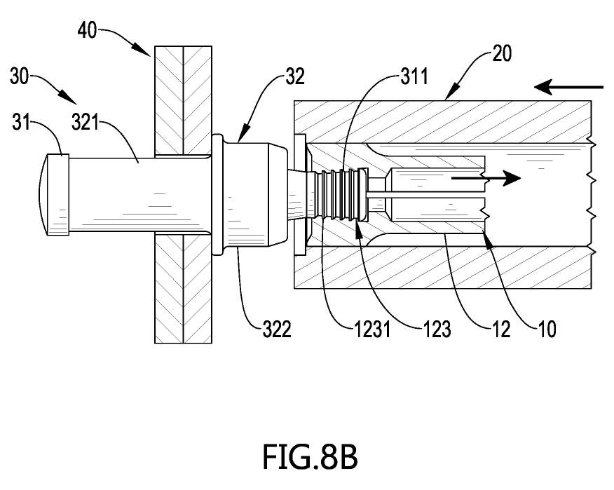

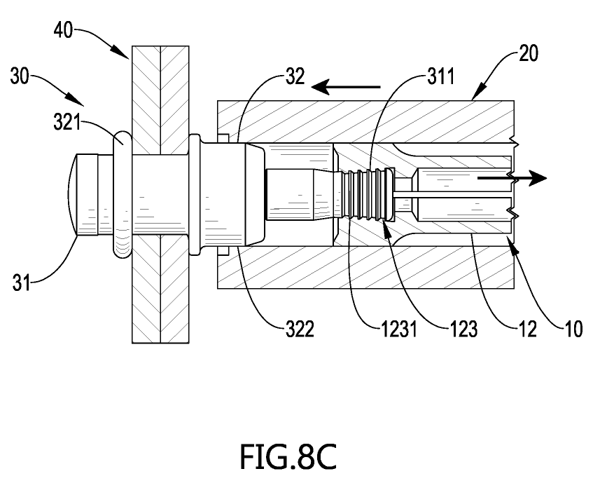

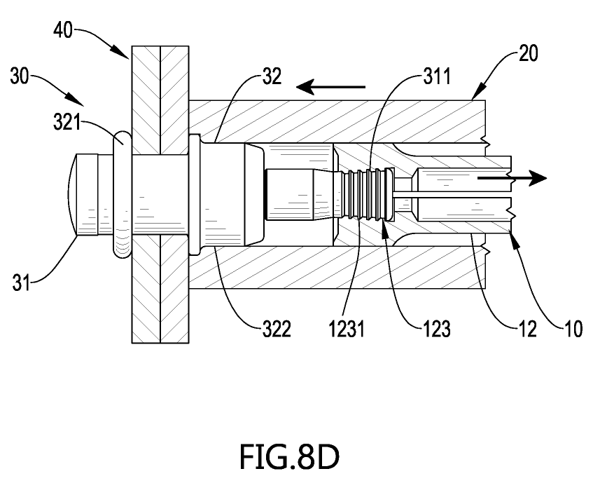

With reference to FIGS. 7A to 7C and 8A to 8D, the drilling step is to drill holes on the multiple components of the to-be-riveted object 40 beforehand. Diameters of the holes depend on needs and the size of rivet assembly 30. For example, when using a dual-directional rivet assembly 30, the diameters of the drilled holes are slightly larger than a diameter of a rod 310 of a mandrel 31 of the rivet assembly 30, and smaller than a diameter of a mandrel head of the mandrel 31. When using a uni-directional rivet assembly 30, the diameters of the drilled holes are slightly larger than a diameter of a mandrel head of a mandrel 31 of the rivet assembly 30, slightly larger than a diameter of a rivet tube 321 of a rivet body 32 of the rivet assembly 30, and smaller than a diameter of a rivet head 322 of the rivet body 32.

The assembling step depends on whether the rivet assembly 30 is uni-directional or dual-directional. With reference to FIGS. 7A to 7C, when using the dual-directional rivet assembly 30, the mandrel 31 is mounted through the holes on the to-be-riveted object 40 from its rear side to its front side until the mandrel head of the mandrel 31 abuts the rear side of the to-be-riveted object 40. The connecting section 311 of the mandrel 31 extends out of the front side of the to-be-riveted object 40. The rivet body 32 is mounted around the connecting section 311 of the mandrel 31 at the front side of the to-be-riveted object 40. With reference to FIGS. 8A to 8D, when using the uni-directional rivet assembly 30, the rivet body 32 of the rivet assembly 30 is mounted around the connecting section 311 of the mandrel 31 beforehand. Then, the assembled rivet assembly 30 is mounted through the holes on the to-be-riveted object 40 from its front side to its rear side until the mandrel head of the mandrel 31 and a rear section of the rivet tube 321 of the rivet body 32 extend out from a preset location on the rear side of the to-be-riveted object 40. The rivet head 322 of the rivet body 32 abuts the front side of the to-be-riveted object 40, and the connecting section 311 of the mandrel 31 extends outwardly from a front side of the rivet head 322.

With reference to FIGS. 7A to 7C and 8A to 8D, the clamping step is to mount the claw portion 12, which is expanded, of the claw-type rivet-pulling tool 10 around the connecting section 311 of the mandrel 31, then, by the resilience, the claw portion 12 clamps around the connecting section 311. A pulling sleeve 20 mounted outside and around the tool base 11 of the claw-type rivet-pulling tool 10 is pushed toward the rivet assembly 30. The pulling sleeve 20 is located outside of the multiple clamping pieces 121 of the claw portion 12 and limits the multiple clamping pieces 121 in position, thereby ensuring the connecting section 11 of the mandrel 31 is clamped.

With reference to FIGS. 7A to 7C and 8A to 8D, in the clamping step, the guiding inclined surface 1212 on the terminal surface of the tail end 1211 of each one of the multiple clamping pieces 121 at the terminal end of the claw portion 12 is used to guide the connecting section 311 to align with the middle hole 120 of the claw-type rivet-pulling tool 10, thereby facilitating the multiple clamping pieces 121 to be expanded and clamp around the connecting section 311. After the multiple clamping pieces 121 of the claw portion 12 clamp and connect the connecting section 311, the backwardly-pulling clamping portion 123, facing the middle hole 120, of each one of the multiple clamping pieces 121 clamps a backwardly-inclined cone of the connecting section 311. Additionally, each one of the multiple clamping teeth 1231 of said backwardly-pulling clamping portion 123 buckles a radius annular recess, which corresponds in position with said clamping tooth 1231, of said backwardly-inclined cone of the connecting section 311.

With reference to FIGS. 7A to 7C and 8A to 8D, the pulling step is to fix the rivet head 322 of the rivet body 32 through the pulling sleeve 20, then applying an axial force to push it toward the to-be-riveted object 40. At the same time, the claw-type rivet-pulling tool 10 clamps the connecting section 311 of the mandrel 31 and applies a force to pull it toward a direction opposite to the rivet body 32, thereby riveting to fix the components of the to-be-riveted object 40 to each other.

With reference to FIGS. 7A to 7C, in the pulling step, when using the two-directions-operated rivet assembly 30, the rivet head 322 of the rivet body 32 is fixed by the pulling sleeve 20 and is applied with an axial force to be pushed toward the to-be-riveted object 40. The mandrel head of the mandrel 31 abuts the rear side of the to-be-riveted object 40; at the same time, the claw-type rivet-pulling tool 10 clamps the connecting section 311 of the mandrel 31 and applies a force to pull it toward a direction opposite to the rivet body 32. So, the rivet head 322 of the rivet body 32 will deform under the stress. When the rivet head 322 deforms under the stress, the deformed rivet head 322 and the connecting section 311 of the mandrel 31 connect together tightly, thereby riveting to fix the components of the to-be-riveted object 40 to each other.

With reference to FIGS. 8A to 8D, in the pulling step, when using the uni-directional rivet assembly 30, the rivet head 322 of the rivet body 32 is fixed by the pulling sleeve 20 and is applied with an axial force to be pushed toward the to-be-riveted object 40. At the same time, the claw-type rivet-pulling tool 10 clamps the connecting section 311 of the mandrel 31 and applies a force to pull it toward a direction opposite to the rivet body 32. A rear section of the rivet tube 321 of the rivet body 32 is pushed by the mandrel head to deform, therefore forming a protrusion with an expanded radial diameter at the rear side of the to-be-riveted object 40. Then the rivet head 322 of the rivet body 32 is deformed by the pulling sleeve 20 applying the axial force. When the rivet head 322 deforms under the stress, the deformed rivet head 322 and the connecting section 311 of the mandrel 31 connect together tightly, thereby riveting to fix the components of the to-be-riveted object 40 to each other.

In the pulling step, the claw portion 12 of the claw-type rivet-pulling tool 10 clamps the connecting section 311 of the mandrel 31. An inner surface of the backwardly-pulling clamping portion 123 of the claw portion 12 clamps and connects the backwardly-inclined cone of the connecting section 311, thereby having a larger gripping area. Additionally, the multiple clamping pieces 121, arranged annularly, of the claw portion 12 clamp the multiple radius annular recesses on a periphery of the connecting section 311 respectively through the multiple clamping teeth 1231, which protrude radially. The connection between the multiple clamping teeth 1231, having a radial difference between each two adjacent clamping teeth 1231, and the multiple radius annular recesses enlarge a gripping area between the claw portion 12 and the connecting section 311. Therefore, when the claw-type rivet-pulling tool 10 clamps the connecting section 311 of the mandrel 31 to process the pulling step, a larger gripping force is generated between the claw-type rivet-pulling tool 10 and the connecting section 311. Simultaneously, areas where the claw-type rivet-pulling tool 10 generates the gripping force toward the connecting section 311 of the mandrel 31 are distributed as multiple concentric circles with different radiuses. The multiple clamping teeth 1231 of the claw portion 12 of the claw-type rivet-pulling tool 10 respectively reach into different radius annular recesses of the connecting section 311 that have different radial depths. The outermost clamping tooth 1231 reaches into the deeper radius annular recess, while the other clamping teeth 1231 reach into the other radius annular recesses that have the depths decreasing from outside to inside sequentially. Therefore, the connecting section 311 is more stably clamped to apply force, contributing to the claw-type rivet-pulling tool 10 pulling the mandrel 31, and the pulling sleeve 20 applying force to the rivet head 322 of the rivet body 32 for deformation.

In addition, the claw-type rivet-pulling tool 10 uses the inner surface of the backwardly-pulling clamping portion 123 of the claw portion 12 cooperating with the blocking stepped surface 124 at the lateral end of the backwardly-pulling clamping portion 123 inside the claw portion 12 to more stably clamp the connecting section 311 of the mandrel 31 to apply force, ensuring that the mandrel 31 does not slip and detach while being pulled.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A claw-type rivet-pulling tool comprising:
a tool base;
a claw portion disposed at an end of the tool base and comprising
multiple clamping pieces, which are flexible and are expanded or contracted when operated;
a middle hole elongated from a terminal end of the claw portion into the tool base;
each one of the multiple clamping pieces comprising
a tail end;
a backwardly-pulling clamping portion disposed at an inner wall of the tail end;
the multiple clamping pieces configured to collaboratively clamp a mandrel of a rivet assembly through the backwardly-pulling clamping portion to pull the mandrel.

2. The claw-type rivet-pulling tool as claimed in claim 1, wherein the backwardly-pulling clamping portion comprises
multiple clamping teeth;
each two adjacent clamping teeth have a radial difference formed therebetween.

3. The claw-type rivet-pulling tool as claimed in claim 1, wherein each one of the multiple clamping pieces comprises
a blocking stepped surface formed in an inner wall of said clamping piece and disposed between the multiple clamping teeth and the tool base.

4. The claw-type rivet-pulling tool as claimed in claim 2, wherein each one of the multiple clamping pieces comprises
a blocking stepped surface formed in an inner wall of said clamping piece and disposed between the multiple clamping teeth and the tool base.

5. The claw-type rivet-pulling tool as claimed in claim 1, wherein each one of the multiple clamping pieces comprises a guiding inclined surface disposed at a terminal surface of the tail end of said clamping piece.

6. The claw-type rivet-pulling tool as claimed in claim 2, wherein each one of the multiple clamping pieces comprises a guiding inclined surface disposed at a terminal surface of the tail end of said clamping piece.

7. The claw-type rivet-pulling tool as claimed in claim 3, wherein each one of the multiple clamping pieces comprises a guiding inclined surface disposed at a terminal surface of the tail end of said clamping piece.

8. The claw-type rivet-pulling tool as claimed in claim 4, wherein each one of the multiple clamping pieces comprises a guiding inclined surface disposed at a terminal surface of the tail end of said clamping piece.

9. The claw-type rivet-pulling tool as claimed in claim 1, wherein the tool base comprises
an assembling hole communicating with the middle hole;
an installing hole disposed at a peripheral wall of the tool base and communicating with the assembling hole;
a ball seat mounted at the installing hole; and
a steel ball mounted in the ball seat.

10. The claw-type rivet-pulling tool as claimed in claim 4, wherein the tool base comprises
an assembling hole communicating with the middle hole;
an installing hole disposed at a peripheral wall of the tool base and communicating with the assembling hole;
a ball seat mounted at the installing hole; and
a steel ball mounted in the ball seat.

11. The claw-type rivet-pulling tool as claimed in claim 8, wherein the tool base comprises
an assembling hole communicating with the middle hole;
an installing hole disposed at a peripheral wall of the tool base and communicating with the assembling hole;
a ball seat mounted at the installing hole; and
a steel ball mounted in the ball seat.

12. The claw-type rivet-pulling tool as claimed in claim 1, wherein the claw portion is elongated along a central axis;
the backwardly-pulling clamping portion of each one of the multiple clamping pieces extends inwardly from the tail end of said clamping piece and inclines away from the central axis of the claw portion.

13. The claw-type rivet-pulling tool as claimed in claim 11, wherein the claw portion is elongated along a central axis;
the backwardly-pulling clamping portion of each one of the multiple clamping pieces extends inwardly from the tail end of said clamping piece and inclines away from the central axis of the claw portion.
